(19) United States
(12) Patent Application Publication
(10) Pub. No.: US 2023/0338984 A1
(43) Pub. Date: Oct. 26, 2023

(54) Self Piercing Cap for Soft Walled Packaging or Chub

(71) Applicant: Ingersoll Products Inc., Ingersoll (CA)

(72) Inventor: James Pentland, London (CA)

(73) Assignee: Ingersoll Products Inc., Ingersoll (CA)

(21) Appl. No.: 18/306,310

(22) Filed: Apr. 25, 2023

Related U.S. Application Data
(60) Provisional application No. 63/334,415, filed on Apr. 25, 2022.

(51) Int. Cl. B65D 83/00; B05C 17/01; B05C 17/005

(52) U.S. Cl. CPC B05C 17/00586; B05C 17/00513; B05C 17/01; B65D 83/0072

(57) ABSTRACT

A cap for receiving over an end of a flexible tube or chub. The cap comprises a hollow body member having a downwardly depending skirt and an opening through which material from within the flexible tube or chub can be extruded. Within the hollow body member is a hollow compartment that is in part defined by the skit and that receives the flexible tube or chub with the skirt sealingly received thereabout. Within the hollow compartment there is situated a plurality of cutters configured to pierce the flexible tube or chub upon compressing the flexible tube or chub into the cap. Upon the piercing of the flexible tube or chub, compressive force applied to the flexible tube or chub causes material therein to flow into the hollow compartment and through the opening.

### FIELD

This invention relates generally to the field of soft walled packaging, tubes, or chubs that may be used to store and to dispense a wide variety of different types of materials. In one embodiment the invention relates to a self piercing cap for a tube or chub that may contain caulking or other viscous or granular materials.

### BACKGROUND

Caulking, adhesives, silicone, drywall compound, spackle, plaster, and other such materials are often sold in soft walled packaging, tubes, flexible casings, cartridges, and the like. When packaged and sold in such a manner, these types of materials are typically dispersed through the application of pressure to the casing or container, forcing the material inside through a nozzle at one end. Where the material in question is contained within a flexible tubular casing, one end may be sealed such that applying pressure to the exterior circumference or to the sealed end of the casing causes the material to be extruded through a cap/nozzle fixed upon the opposite end, much like in the case of a tube of toothpaste.

Traditionally, the tubes within which materials in the nature of the above have been packaged and dispersed have been in the form of a rigid or a semi rigid plastic tube or sleeve which is designed for receipt within a caulking gun. In use, a plunger of the caulking gun applies pressure to one end of the sleeve in order to expel its contents through the other end. More recently, tubular casings formed from thin flexible material in the form of a tubular or sausage-shaped package, commonly known as a chub, have become a common means to retain and sell materials of the nature of those described above. These flexible casings or chubs offer advantages in form of a reduction in plastic usage, a reduction in the production of plastic waste, and reduced cost.

There is a continuing need for improvements in the caps/nozzles that are used in conjunction with flexible chubs so that they remain simple to operate and maintain the contents within the chub until such time as it is desired to dispense them. There is also a need for an improvement in the manner in which chubs are “opened”. Current means of opening chubs include cutting the chub’s fastener or clip from its cinched end and/or piercing the chub with a knife. Both of such means can result in the leakage of the contents of the chub and/or the need to clean cutting utensils.

### SUMMARY

In an embodiment there is provided a cap for receiving over an end of a flexible tube or chub of the type that contains a material for extrusive application to a surface, the cap comprising a hollow body member having a first end and a second end, the first end of the hollow body member having a downwardly depending skirt, the hollow body member, at its second end, having an opening through which material from within the flexible tube or chub can be extruded; wherein, within the hollow body member there is situated a hollow compartment in fluid communication with the opening, the hollow compartment at least in part defined by the skirt, the hollow compartment dimensioned to receive the first end of the flexible tube or chub with the skirt sealingly received about the first end of the flexible tube or chub; wherein, within the hollow compartment there is situated a plurality of cutters, the cutters configured to pierce an exterior surface of the first end of the flexible tube or chub when sealingly received within the hollow compartment and upon the application of a compressive force to the flexible tube or chub that compresses the first end of the flexible tube or chub into the cap; wherein, upon the piercing of the exterior surface of the flexible tube or chub compressive force applied to the flexible tube or chub causes material retained therein to flow into the hollow compartment and through the opening.

In a further embodiment the invention provides a cap for receiving over an end of a flexible tube or chub of the type that contains a material for extrusive application to a surface, the cap comprising a hollow body member having a first end and a second end, the first end of the hollow body member having a downwardly depending skirt, the hollow body member, at its second end, having an opening through which material from within the flexible tube or chub can be extruded; wherein, within the hollow body member there is situated a hollow compartment in fluid communication with the opening, the hollow compartment at least in part defined by the skirt, the hollow compartment dimensioned to receive the first end of the flexible tube or chub with the skirt sealingly received about the first end of the flexible tube or chub; wherein, within the hollow compartment there is situated a plurality of cutters, the cutters configured to pierce an exterior surface of the first end of the flexible tube or chub when sealingly received within the hollow compartment and upon the application of a compressive force to the flexible tube or chub that compresses the first end of the flexible tube or chub into the cap; wherein, the hollow compartment contains a plurality of supports that contact the first end of the flexible tube or chub when received within the hollow compartment; wherein the hollow body further comprises one or more retainers therein, the one or more retainers assisting in preventing the first end of the flexible tube or chub from entering the opening; wherein, upon the piercing of the exterior surface of the flexible tube or chub compressive force applied to the flexible tube or chub causes material retained therein to flow into the hollow compartment and through the opening.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a side exploded view of a soft walled packaging, flexible casing, or chub prior to application of its end cap.

FIG. 2 is a side schematic view of a caulking gun having received therein the chub and cap combination of the FIG. 1.

FIG. 3 is a view subsequent to FIG. 2, wherein the plunger of the caulking gun has compressed the chub to expel a portion of its contents through an opening in the cap.

FIG. 4 is an upper side perspective view of the cap shown in FIG. 1.

FIG. 5 is a bottom side perspective view of the cap of FIG. 4.

FIG. 6 is a bottom perspective view of the cap of FIG. 4.

FIG. 7 is a top view of the cap of FIG. 4.

FIG. 8 is a bottom view of the cap of a FIG. 4.

FIG. 9 is a side elevational view of the cap of FIG. 4.

FIG. 10 is a sectional view taken along the line 10-10 of FIG. 8.

FIG. 11 is a sectional view taken along the line 11-11 of a FIG. 8.

FIG. 12 is a side sectional view through the end of an alternate form of caulking gun to that shown in FIGS. 2 and 3, having received therein a flexible casing or chub and having a cap constructed in accordance with an embodiment of the invention secured thereto.

FIG. 13 is an upper side perspective view of a cap constructed in accordance with an alternate embodiment of the invention to that shown in FIG. 4 and having an integrated nozzle.

FIG. 14 is an upper side perspective view similar to FIG. 13, wherein the nozzle is threadably received on the end of the cap.

FIG. 15 is a bottom view of an embodiment of the caps shown in FIGS. 13 and 14.

FIG. 16 is a bottom view of an alternate embodiment of the invention of the cap shown in FIG. 15.

### DESCRIPTION

The present invention may be embodied in a number of different forms. The specification and drawings that follow describe and disclose some of the specific forms of the invention.

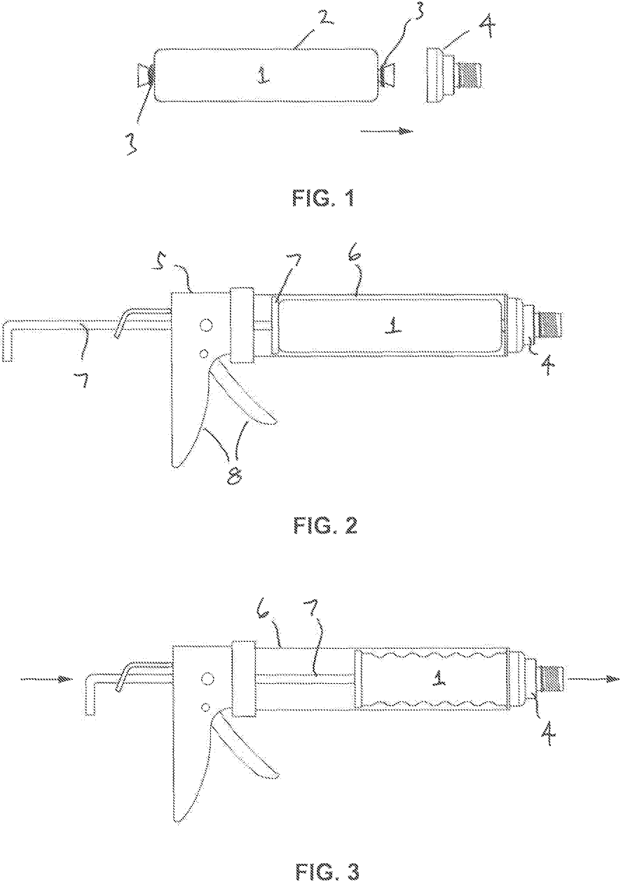

With reference to FIGS. 1 through 3, there is shown a relatively generic soft walled packaging or flexible tube (or a chub as it may commonly be referred to) denoted by reference character 1. Chub 1 is comprised generally of a flexible exterior casing 2 that is in a tubular form and enclosed at each end. It will be appreciated that casing 2 could be filled with any one of a very wide variety of different materials, including, but not limited to, caulking, silicone, glues or adhesives, mastic, drywall compound, grease, granular materials, etc. Typically, casing 2 would be formed from a thin, flexible, plastic or plastic-like material. Casing 2 may be commonly enclosed at each of its ends once filled with the material of choice by cinching the ends and retaining them in a closed configuration through the use of a mechanical fastener 3. In other embodiments the ends of the casing may be cinched and retained in a closed configuration through the use of an adhesive, through heat welding, or through other forms of clasping or retaining members. Regardless of the manner in which the ends of the casing are enclosed, the result will be the formation of a tube or chub filled with a desired material, retained within the casing until the casing is pierced and the chub compressed to expel the material.

In accordance with the invention there is provided a cap 4 that is secured to one end of the casing in order to both provide a means to pierce the casing when it is desired to expel material retained therein, and that also provides a means to direct the flow of the material as it exits the casing. Cap 4 may be secured to one end of casing 2 through a variety of different means, including, but not limited to, mechanical bonding through the use of mechanical fasteners, through the use of adhesives, and through heat welding. From a thorough understanding of the invention described below, it will be understood that securing cap 4 to one end of casing 2 does not in itself pierce the casing, and that the casing remains fully intact and enclosed after the cap has been secured to one end thereof, until such time as a user desires to dispense the casing’s contents.

FIGS. 2 and 3 demonstrate the use of casing 2, having cap 4 secured thereto, in a standard caulking gun 5. In the embodiment shown caulking gun 5 is a standard or traditional caulking gun that is generally comprised of a main body or housing 6 that retains chub 1, a plunger 7, and a handle or trigger that is activated to advance plunger 7. FIG. 2 demonstrates the receipt of chub 1 within housing 6 of caulking gun 5, with the outer end of cap 4 extending through the end of caulking gun 5. In this figure, plunger 7 is in slight contact with the opposite end of casing 2, but is not applying significant pressure to the casing. FIG. 3 schematically demonstrates the effect of activating handle or trigger 8 to advance plunger 7, and to thereby compress casing 2 within housing 6. As the plunger advances, casing 2 is compressed, the end of the casing opposite to the plunger is pierced by cap 4 (as will be described in further detail), and the contents of the casing are expelled through the end of cap 4.

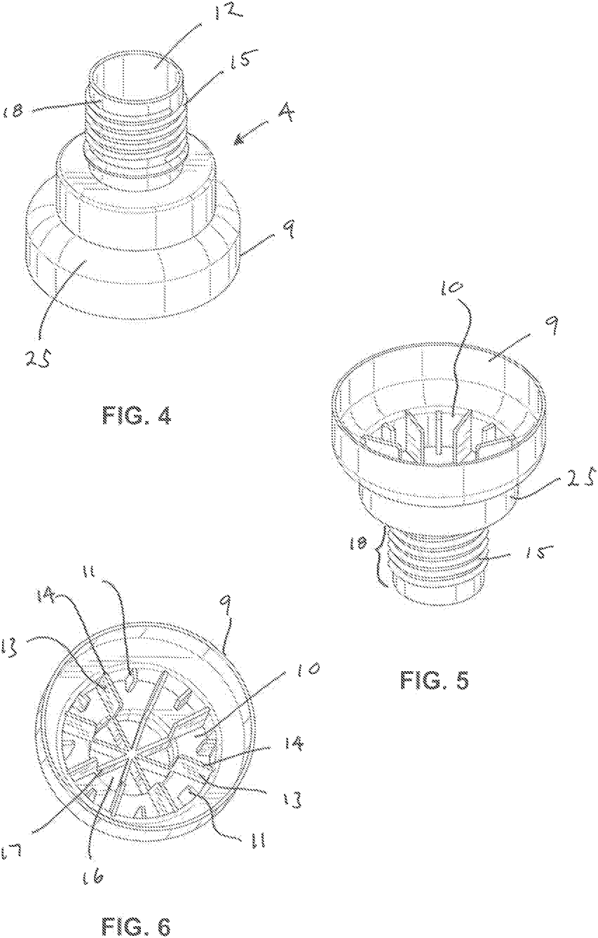

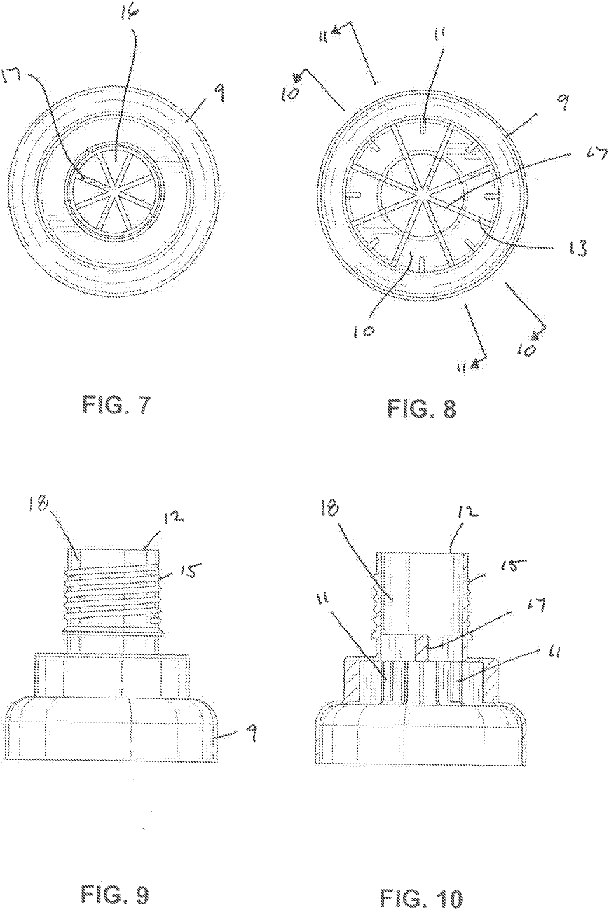

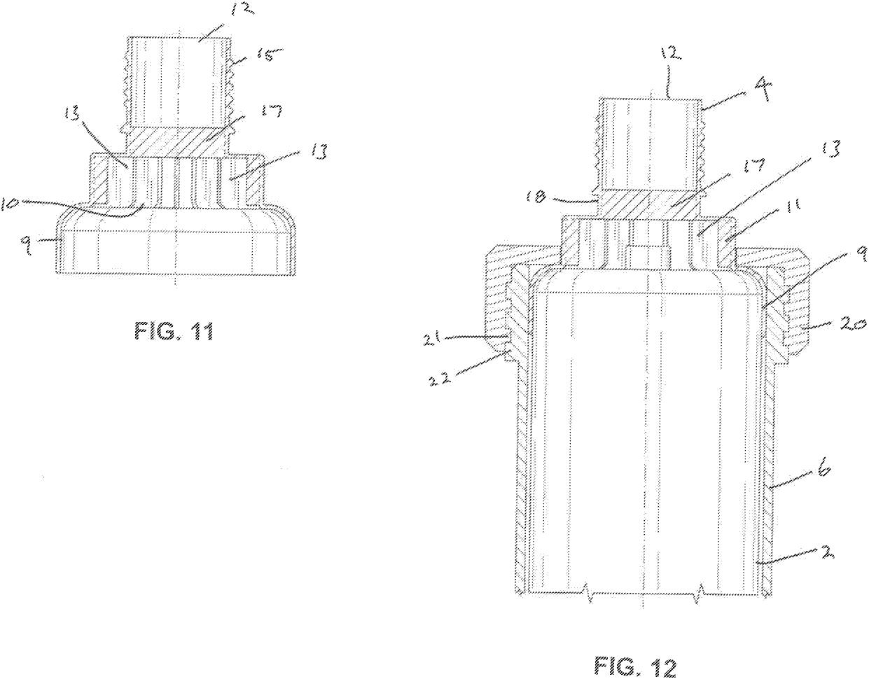

With reference to FIGS. 4 through 11, the structure of the embodiment of cap 4 that is depicted in the drawings will now be described in further detail. In the embodiment shown cap 4 is comprised of a hollow body member 25 that includes a downwardly depending circumferential skirt 9 that is received about one end of casing 2 and that in part defines a hollow compartment 10 within hollow body 25. Skirt 9 may be formed and sized in a manner that allows it to be secured to the casing through the application of an adhesive on the interior surface of the skirt. Other forms of attachment are contemplated.

Hollow compartment 10 is sized and configured to receive the cinched or otherwise enclosed end of casing 2 when cap 4 is secured about the exterior of one end of the casing. It will be understood that where a mechanical fastener or clip is used to hold the cinched end of casing 2 closed, that fastener or clip will also be housed within compartment 10 when cap 4 is secured to the casing.

One or more cutters 11 may be situated within compartment 10. Cutters 11 perform the function of piercing or cutting casing 2 in order to permit the contents of the casing to be expelled when desired. Cutter or cutters 11 may take any one of a wide variety of different structures and configurations. In the embodiment shown, cutters 11 comprise a plurality of generally rectangular, knife-like structures having relatively sharp lower ends that contact the casing when plunger 7 compresses the casing into cap 4. That is, with cap 4 secured to the end of casing 2, and with chub 1 received within housing 6 of caulking gun 5, driving the plunger toward chub 1 will compress the chub into cap 4 since the cap will be restricted from longitudinal movement by the end of the caulking gun. As the chub is compressed by the plunger, its contents will be driven toward cap 4 causing the cinched end of casing 2 to be pushed longitudinally into cutter or cutters 11, thereby cutting or piercing the end of the chub. As pressure upon the chub is maintained by plunger 7, the contents of the chub will be expelled into compartment 10, and ultimately out an opening 12.

In the particular embodiment shown in the FIGS. 4 - 12 there are eight cutters 11 spaced apart at an approximately equal distance about the interior circumference of compartment 10. Other numbers and configurations of cutters are possible. Depending upon the nature of the material retained within casing 2, it may be desirable to incorporate more, fewer, larger, or smaller cutters. In some instances it may be desirable to increase the number and/or size of the cutters in order to encourage the formation of more or larger cuts or openings to permit the material to be forced out of casing 2. In other instances a fewer number and/or smaller cutters may be sufficient to permit an adequate expulsion of the contents of the casing. When cap 4 is circular in cross section, cutters 11 may be oriented along one or more diameters of the cap.

It will be appreciated that it will not only be desirable to present a structure that allows for the piercing or cutting of the end of the chub, but also a structure that helps to prevent a premature cutting of casing 2 that would result in an undesirable expulsion of its contents or the exposure of the contents to air. For example, when a chub with cap 4 secured thereto is on display by a retail distributor, it will be desirable to help ensure that the mere act of picking up the chub in one’s hand does not apply sufficient pressure to its contents that will force the end of the chub into cutter or cutters 11 and pierce or cut the end of the casing. For this reason, in an embodiment of the invention compartment 10 may be also fitted with one or more supports 13 that extend in a downward direction toward skirt 9, past the lower ends up cutters 11. In the embodiment depicted in the attached drawings, supports 13 comprise a series of eight, generally rectangular shaped, baffles having relatively blunt lower ends 14 that contact the end of chub 1 when cap 4 is secured thereto. Since lower ends 14 of supports or baffles 13 extend downwardly further than cutter or cutters 11, they will contact the enclosed end of casing 2 before the casing is driven into the cutters when placed under compression. In this manner, supports or baffles 13 help to prevent cutters 11 from cutting or piercing casing 2 until such time as a compressive force is applied to the casing that is sufficient to drive the enclosed end of the casing past supports 13 and into contact with cutter or cutters 11. In an embodiment, cutters 11 are flanked on each of their sides by a support 13. Supports or baffles 13 thereby help to prevent the premature cutting or piercing of the end of casing 2 by precluding contact between the casing and the cutter or cutters until it is desired to expel the contents of the casing. In the embodiment shown, eight supports or baffles 13 are positioned approximately equally distant around the interior circumference of compartment 10. Other configurations and numbers of supports or baffles could be used. It will also be appreciated that the number, configuration and positioning of the supports or baffles will to a degree be a function of the particular material from which casing 2 is constructed, its properties, and its flexibility. When cap 4 is circular in cross section, supports or baffles 13 may be oriented along one or more diameters of the cap, which may be different diameters from those along which cutters 11 are positioned.

When chub 1 is compressed, such as would be the case when pressure is exerted upon the chub by plunger 7 of caulking gun 5, the enclosed end of casing 2 will eventually be driven into contact with cutter or cutters 11 that cut or pierce the casing. The continued application of pressure upon the chub will force the material stored within the casing to flow through the openings or piercings in the end of the chub until the material fills compartment 10, after which continued pressure on the chub will expel material through opening 12. Opening 12 may be positioned at the end of a generally cylindrical portion 18 of cap 4 that has an external thread 15 to which any wide variety of different applicators could be secured. Thread 15 may also provide an ability to enclose the opening 12 through the use of a threaded lid to enclose and seal opening 12 between uses.

In an embodiment of the invention, the lower end or entrance 16 of cylindrical portion 18 (situated at the junction of cylindrical portion 18 and compartment 10) may be fitted with a retainer 17 that is designed to retain or secure the cinched end of casing 2 and/or a fastener 3 (where such a fastener has been used) in order to prevent the cinched end and/or the fastener from being expelled into cylindrical portion 18 or into opening 12. That is, as the casing is compressed into cap 4 there will be a tendency for the cinched end of the casing, and/or any fastener that is used to enclose the casing, to be driven into cylindrical portion 18. Should the cinched end and/or fastener be allowed into cylindrical portion 18, it could potentially plug opening 12 or otherwise hinder the flow of material therethrough. Retainer 17 thereby helps to maintain both the cinched end of the casing and any fastener that may be present within compartment 10. In the embodiment shown in the attached the drawings, retainer 17 is in the form of a series of thin rectangular arms that form a generally starburst pattern within the portion 18. Other grids of arms or similar structures could be used, as well as other forms of mechanical devices designed to help prevent the movement of the end of the casing and/or a fastener into cylindrical portion 18.

FIG. 12 shows an alternate embodiment of the invention. Here, rather than securing cap 4 directly to the casing of the chub, the cap is maintained as a separate component that is held within the open end of housing 6 of caulking gun 5 through the use of a retaining nut or end cap 20. That is, in operation, chub 1 is slid into the interior of an open ended tube or into housing 6. Cap 4 can then be inserted into nut 20 with cylindrical portion 18 extending outwardly through a central hole or opening in nut 20. Nut 20 is then threaded (see threads 21 and 22 in FIG. 12) or otherwise secured to the open end of the tube or housing 6, with the cinched end of the chub generally received within the central portion of compartment 10. A compressive forced applied to the chub though operation of handle 8 causes an advancement of plunger 7 that forces the end of the chub into contact with cutters 11 and supports 13. The end of casing 2 will at that point be cut or pierced, and material from within the chub will flow into compartment 10 and then eventually out through opening 12. When the contents of the chub have been expelled from casing 2, nut 20 and cap 4 can be removed from the open ended tubing or from housing 6 to permit the spent chub casing to be removed and discarded. A new chub can then be inserted into the housing, the cap and nut again secured to the housing, and the contents of the new chub expelled through operation of handle 8. Where the contents of the new chub are different from those which it replaces, it may be desirable to replace cap 4 with a new or clean cap prior to re-installing nut 20.

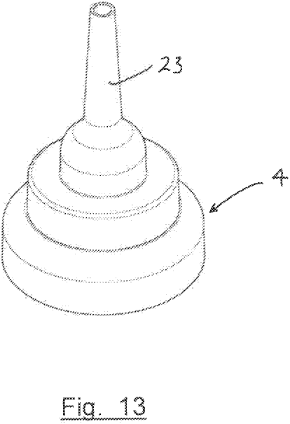

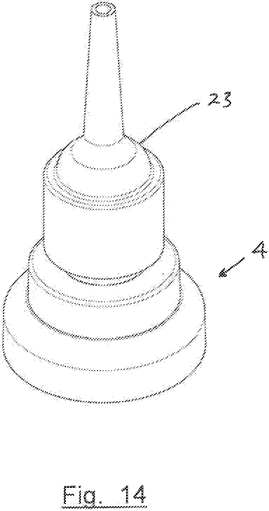

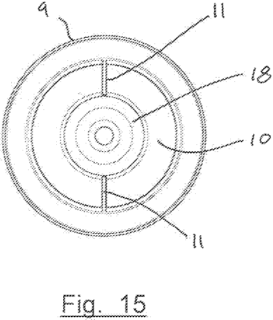

With reference to FIGS. 13 through 16, there is shown yet a further embodiment of the invention. In the case of FIG. 13, cap 4 has an integral nozzle 23. In the case of the embodiment shown in FIG. 14, nozzle 23 is a removable feature that can be releasably secured to the cap, typically by threading the nozzle onto threads 15 of cylindrical portion 18. It will be appreciated that in the case of FIG. 14, different shapes and configurations of nozzles could be secured to the end of cap 4 as desired, depending upon the nature of the material to be expelled from casing 2, and depending upon the nature of the end use of the expelled material. The embodiment of FIG. 14 further permits nozzles to be replaced if damaged or if material within them becomes solidified.

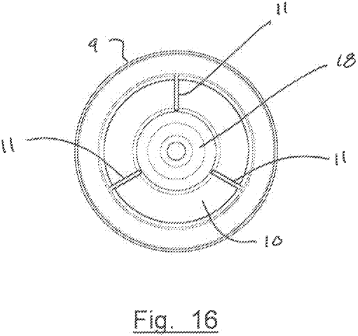

FIGS. 15 and 16 depict alternate embodiments of the interior of cap 4 to that shown in FIGS. 5, 6, and 8. The primary differences in the embodiments shown in FIGS. 15 and 16 is the elimination of supports or baffles 13; the utilization of somewhat larger, but fewer in number, cutters 11; and the elimination of retainer 17. In the case of the embodiment shown in FIG. 15, two diametrically opposed cutters 11 are utilized. In the case of the embodiment shown in FIG. 16, three cutters 11 are utilized, each separated by approximately 120 degrees. Otherwise, the interior and functionality of the caps shown in FIGS. 15 and 16 are largely the same as that shown in FIGS. 5, 6, and 8. The more minimalistic interior of the embodiments shown in FIGS. 15 and 16 will present fewer restrictions to the flow of material through the cap and also fewer chances of portions of casing 2, and/or any form of mechanical fastener used to enclose the casing, from being detrimental to a generally unobstructed and even flow of material through cap 4. It will be appreciated that the embodiment of FIGS. 15 and/or 16 may be more conducive to use in association with particular diameters of chubs or with chubs which contain particular types of materials for extrusion.

It is to be understood that what has been described are the preferred embodiments of the invention. The scope of the claims should not be limited by the preferred embodiments set forth above, but should be given the broadest interpretation consistent with the description as a whole.

I claim:

1. A cap for receiving over an end of a flexible tube or chub of the type that contains a material for extrusive application to a surface, the cap comprising:
a hollow body member having a first end and a second end, the first end of the hollow body member having a downwardly depending skirt, the hollow body member, at its second end, having an opening through which material from within the flexible tube or chub can be extruded,
wherein, within the hollow body member there is situated a hollow compartment in fluid communication with the opening, the hollow compartment at least in part defined by the skirt, the hollow compartment dimensioned to receive the first end of the flexible tube or chub with the skirt sealingly received about the first end of the flexible tube or chub,
wherein, within the hollow compartment there is situated a plurality of cutters, the cutters configured to pierce an exterior surface of the first end of the flexible tube or chub when sealingly received within the hollow compartment and upon the application of a compressive force to the flexible tube or chub that compresses the first end of the flexible tube or chub into the cap,
wherein, upon the piercing of the exterior surface of the flexible tube or chub compressive force applied to the flexible tube or chub causes material retained therein to flow into the hollow compartment and through the opening.

2. The cap as claimed in claim 1 where in the cutters are orientated radially within the hollow compartment, each cutter an equal distance from an adjacent cutter.

3. The cap as claimed in claim 2 having two cutters, spaced apart horizontally by 180 degrees.

4. The cap as claimed in claim 2 having three cutters, each spaced apart horizontally from an adjacent cutter by 120 degrees.

5. The cap has claimed in claim 1 wherein the hollow compartment contains a plurality of supports that contact the first end of the flexible tube or chub when received within the skirt.

6. The cap as claimed in claim 5 wherein the supports extend toward the flexible tube or chub to a greater extent than the cutters.

7. The cap as claimed in claim 5 wherein the cap is circular in cross section and the cutters and the supports extend along portions of lines of diameter of the cap.

8. The cap as claimed in claim 7 wherein the cutters extend along lines of diameter of the cap that are different from those along which the supports extend.

9. The cap as claimed in claim 8 wherein each cutter is flanked on each side by a support.

10. The cap as claimed in claim 1 further comprising one or more retainers positioned within the hollow body, the one or more retainers assisting in preventing the first end of the flexible tube or chub from entering the opening.

11. The cap as claimed in claim 10 wherein the retainer comprises a plurality of arms extending across the hollow compartment.

12. The cap as claimed in claim 1 wherein the hollow body member is sized and configured to be receivable within a caulking gun.

13. A cap for receiving over an end of a flexible tube or chub of the type that contains a material for extrusive application to a surface, the cap comprising:
a hollow body member having a first end and a second end, the first end of the hollow body member having a downwardly depending skirt, the hollow body member, at its second end, having an opening through which material from within the flexible tube or chub can be extruded,
wherein, within the hollow body member there is situated a hollow compartment in fluid communication with the opening, the hollow compartment at least in part defined by the skirt, the hollow compartment dimensioned to receive the first end of the flexible tube or chub with the skirt sealingly received about the first end of the flexible tube or chub,
wherein, within the hollow compartment there is situated a plurality of cutters, the cutters configured to pierce an exterior surface of the first end of the flexible tube or chub when sealingly received within the hollow compartment and upon the application of a compressive force to the flexible tube or chub that compresses the first end of the flexible tube or chub into the cap,
wherein, the hollow compartment contains a plurality of supports that contact the first end of the flexible tube or chub when received within the hollow compartment,
wherein the hollow body further comprises one or more retainers therein, the one or more retainers assisting in preventing the first end of the flexible tube or chub from entering the opening,
wherein, upon the piercing of the exterior surface of the flexible tube or chub compressive force applied to the flexible tube or chub causes material retained therein to flow into the hollow compartment and through the opening.

14. The cap as claimed in claim 13 wherein each cutter is flanked on each side by a support.

15. The cap as claimed in claim 13 wherein the cap is circular in cross section and the cutters and the supports extend along portions of lies of diameter of the cap.

16. The cap as claimed in claim 14 wherein the cutters extend along lines of diameter of the cap that are different from those along which the supports extend.

17. The cap as claimed in claim 15 wherein the supports extend along portions of lines of diameter of the cap.
